(19) United States
(12) Patent Application Publication
(10) Pub. No.: US 2015/0125186 A1
(43) Pub. Date: May 7, 2015

(54) DEVELOPING APPARATUS

(71) Applicant: CANON KABUSHIKI KAISHA, Tokyo (JP)

(72) Inventor: Fumitake Hirobe, Ushiku-shi (JP)

(21) Appl. No.: 14/529,433

(22) Filed: Oct. 31, 2014

(30) Foreign Application Priority Data
Nov. 1, 2013 (JP) 2013-228590

(51) Int. Cl. G03G 15/09

(52) U.S. Cl. CPC G03G 15/0812
USPC 399/269; 399/274

(57) ABSTRACT

A developing apparatus includes a developing container for containing a developer; a rotatable developer carrying member provided at the position of the developing container opposed to an image bearing member and configured to carry the developer into a developing zone where the developer carrying member is opposed to the image bearing member; and a guiding portion provided opposed to a carrying region, with respect to an axial direction of the developer carrying member, where the developer carrying member carries the developer, in a side of the developing container remote from the image bearing member, the guiding portion being capable of guiding the developer from an end portion of the developer carrying member with rotation of the developer carrying member.

### FIELD OF THE INVENTION AND RELATED ART

The present invention relates to a developing apparatus usable with an image forming apparatus of an electrophotographic type or an electrostatic recording type.

A developing apparatus is known in which an electrostatic latent image formed on an image bearing member through an electrophotographic type or electrostatic recording type process is developed with a one component developer or a two component developer (developer). The developing apparatus includes a developing sleeve for carrying a developer to supply the toner to the image bearing member such as a photosensitive drum. In such a developing apparatus, the developer carried on the developing sleeve may move to one or the other end portion (sleeve end portion) of the developing sleeve during the feeding of the developer, that is, the rotation of the developing sleeve. When the developer moves to the sleeve end portion, the developer may leak through a bearing to an outside of a developing container. In addition, if the movement of the developer to the sleeve end portion, the developer may stagnate in the bearing supporting the end portion of the developing sleeve.

Therefore, Japanese Laid-open Patent Application 2006-343542) proposes a developing apparatus in which the developer is positively returned toward the central portion of the developing sleeve from the sleeve end portion. In this apparatus, the developing sleeve is provided with a plurality of grooves parallel with the longitudinal direction of the developing sleep, and the grooves are bent at predetermined angle from an arbitrary position away from the left and right end portions over the developing sleeve. With this structure, it is considered that within the range of the grooves, the developer can be returned toward the sleeve central portion in accordance with the rotation of the developing sleeve.

In addition, a structure is known in which a developing chamber for supplying the developer to the developing sleeve and a stirring chamber for collecting the developer from the developing sleeve are arranged vertically (function separating type). With such a structure, the developer is taken up from the lower stage stirring chamber into the upper stage developing chamber, in which the developer tends to stagnate in the downstream side in the stirring chamber with respect to the feeding path. As a result, the developer is unintentionally supplied to the developing sleeve from the stirring chamber, and the developing sleeve keeps carrying the developer (entrainment or dragging of the developer). If the dragging of the developer occurs, there is a possibility of producing developer leakage at the sleeve end portions. It has been propose that a drag suppressing member is provided to prevent the dragging of the developer, by which developer regulating force is made different along the longitudinal direction (Japanese Laid-open Patent Application 2009-151103)). generally, the sleeve end portion is not treated for rough surface using groove formation or blasting or the like. This is because, if such a treatment is effected to the extent of the end portions of the rotatable developing sleeve, the force is applied to the developer during the rotation of the developing sleeve, which may enhance another leakage of the developer. In the case of Japanese Laid-open Patent Application 2006-343542, the grooves formed in the name of food of the sleeve end portions may enhanced such additional leakage from the sleeve end portions.

In addition, even if the dragging suppression member is provided as disclosed in Japanese Laid-open Patent Application 2009-151103, it is difficult to prevent the dragging when the amount of the developer changes, or when the developer agglomerativeness significantly changes, for example. More particularly, the amount of the developer escaping into a region where the developer regulating force is weak, as a result of such a change, and if this occurs, the developer may leak at the end portions. In other to form a uniform thickness developer layer on the surface of the developing sleep, a regulating blade is provided. In the upstream portion of the regulating blade with respect to the developer feeding direction (rotational moving direction) by the developing sleeve, a developer stagnation is produced in which the developer stagnates. Because of the stagnation, the developer is urged toward the regulating blade with a certain degree of pressure, and therefore, the thickness of the developer on the surface of the developing sleeve at the passing under the regulating blade.

However, when the above-described dragging occurs, the pressure increases. And, the developer limited by the regulating blade is moved toward the sleeve end portions with the possible result of the leakage of the sleeve end portions.

Accordingly, it is an object of the present invention to provide a developing apparatus in which the developer leakage in the neighborhood of the end portion of the developing sleeve can be suppressed.

### SUMMARY OF THE INVENTION

According to an aspect of the present invention, there is provided a developing apparatus comprising a developing container for containing a developer; a rotatable developer carrying member provided at the position of said developing container opposed to an image bearing member and configured to carry the developer into a developing zone where said developer carrying member is opposed to said image bearing member; and a guiding portion provided opposed to a carrying region, with respect to an axial direction of said developer carrying member, where said developer carrying member carries the developer, in a side of said developing container remote from said image bearing member, said guiding portion being capable of guiding the developer from an end portion of said developer carrying member with rotation of said developer carrying member.

According to another aspect of the present invention, there is provided a developing apparatus comprising a developing container for containing a developer; a first rotatable developer carrying member provided at the position of said developing container opposed to an image bearing member and configured to carry the developer into a first developing zone where said developer carrying member is opposed to said image bearing member; a second developer carrying member rotatably provided downstream of said first developer carrying member with respect to a rotational moving direction of said image bearing member and configured to carry the developer into a second developing zone four said image bearing member; and a guiding portion provided opposed to a carrying region, with respect to an axial directions of said first and second developer carrying members, where at least one of said first and second developer carrying members carries the developer, in a side of said developing container remote from said image bearing member, said guiding portion being capable of guiding the developer from an end portion of said developer carrying member with rotation of said developer carrying member.

Further features of the present invention will become apparent from the following description of exemplary embodiments with reference to the attached drawings.

### BRIEF DESCRIPTION OF THE DRAWINGS

FIG. 1 is a schematic sectional view illustrating a structure of an image forming apparatus including a developing apparatus according to the present invention.

FIG. 2 is a sectional view illustrating a structure of the developing apparatus according to Embodiment 1.

FIG. 3 is a longitudinal sectional view of the developing container.

FIG. 4 is an enlarged view of a neighborhood of an end portion of a developing sleeve.

FIG. 5 is a schematic view illustrating a dragging reducing member.

FIG. 6 is a sectional view illustrating a structure of the developing apparatus according to Embodiment 2.

FIG. 7 is a sectional view illustrating a structure of the developing apparatus according to Embodiment 3.

### DESCRIPTION OF THE EMBODIMENTS

The preferred embodiments of the present invention will be described in conjunction with the accompanying drawings A developing apparatus according to the present invention is applied to an image forming apparatus which will be described hereinafter, it is not restrictive, and the developing apparatus is usable with other image forming apparatuses. The present invention is applicable to the image forming apparatuses of a tandem type, drum type, intermediary transfer type, direct transfer type or the like. In addition, it is applicable to a two component developer type and a one component developer type. In the following, the description will be made as to the major parts relating to the toner image formation and transfer, and the present invention is applicable to various printers, copying machine, similar machine, complex machine or the like, by add in g parts, equipment, casing necessity for the respective apparatuses.

### Embodiment 1

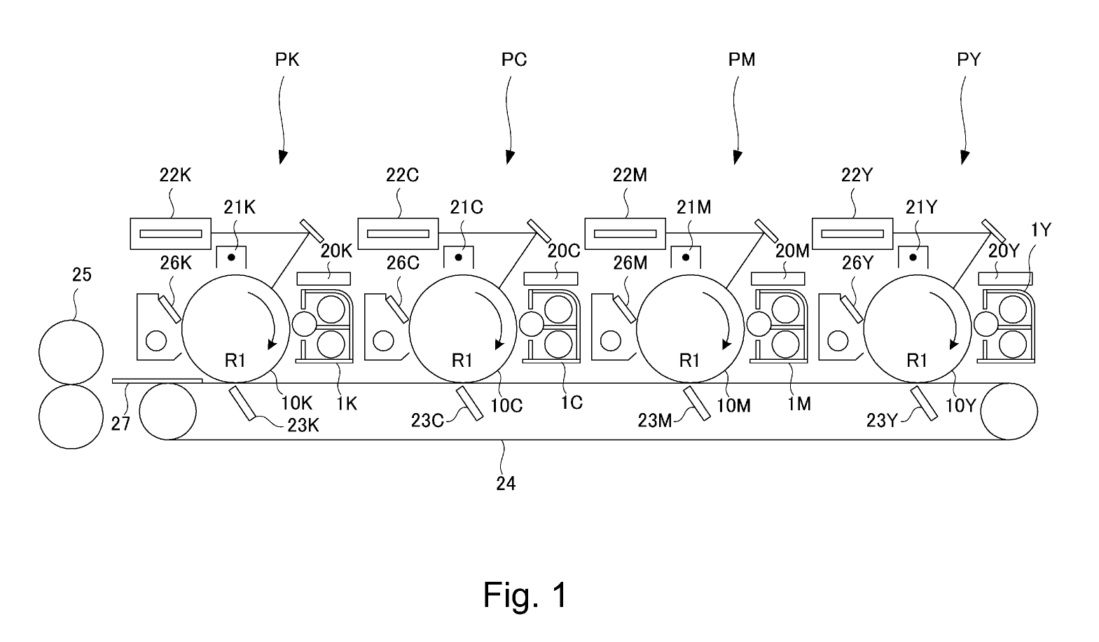

Referring to FIG. 1 through FIG. 5, Embodiment 1 of the present invention will be described. Referring first to FIG. 1, a schematic structure of the image forming apparatus including the developing apparatus according to the present invention will be described.

### [Image Forming Apparatus]

The image forming apparatus shown in FIG. 1 is a full color printer of a tandem type and direct transfer type, in which image forming stations PY, PM, PC and PK are arranged along a transfer material feeding belt 24. In the image forming station PY, a yellow toner image is formed on a photosensitive drum 10Y and is transferred onto a transfer sheet 27 which is a recording material (sheet, OHP or the like) carried on the transfer material feeding belt 24. In the image forming station PM, a magenta toner image is formed on a photosensitive drum 10M, and is transferred onto the transfer sheet 27 carried on the transfer material feeding belt 24. In the image forming station PC, PK, cyan toner image and black toner image are formed on photosensitive drums 10C, 10K, respectively, and they are transferred onto the transfer sheet carried on the transfer material feeding belt 24.

The transfer sheet now having four color toner images is separated from the transfer material feeding belt 24 using the curvature and is fed into a fixing device 25. The transfer sheet 27 is press-heated by the fixing device 25 so that the toner image is fixed on the surface thereof, and thereafter, it is discharged to an outside of the machine.

The image forming stations PY, PM, PC, PK have the same structures except that the colors of the toner contained in the developing apparatuses 1Y, 1M, 1C, 1K are different (, but yellow, magenta, cyan and black). Therefore, the following description of the image forming stations applies commonly to them, although suffixes Y, M, C and K are added in the drawings and only when necessary.

In the image forming station P, there are provided, around the photosensitive drum 10 is a image bearing member, a primary charger 21, an exposure device 22, a developing apparatus 1, a transfer charger 23 and a drum cleaning device 26. Photosensitive drum 10 is provided with a photosensitive layer on the outer peripheral surface thereof and is rotated in the direction indicated by an arrow R1 at a predetermined process speed.

The primary charger 21 projects charged particles produced by corona discharge, for example, and is electrically charges the surface of the photosensitive drum 10 to a negative dark portion potential. The exposure device 22 projects and scans the surface of the photosensitive drum with a laser beam ON-OFF modulated in accordance with scanning line image data indicative of each separated color image, so that an electrostatic latent image is formed on the surface of the charged photosensitive drum 10. The developing apparatus 1 supplies toner onto the photosensitive drum 10 to develop the electrostatic latent image into a toner image.

The transfer charger 23 includes a transfer blade which is press contacted to the transfer material feeding belt 24 to form a toner image transfer portion between the photosensitive drum 10 and the transfer material feeding belt 24. The transfer blade is supplied with a DC voltage of a polarity opposed to the charge polarity of the toner, by which the toner image carried on the photosensitive drum 10 is transferred onto the transfer sheet carried on the transfer material feeding belt 24. So-called untransferred toner remaining on the photosensitive drum 10 after the image after transfer is removed by the drum cleaning device 26.

In this embodiment, the image is transferred from the photosensitive drum 10 directly onto the transfer sheet 27 carried on the transfer material feeding belt 24, but this structure is not restrictive to the present invention. For example, in place of the transfer material feeding belt 24, an intermediary transfer member may be used, in which the respective color toner images are primary-transferred from the photosensitive drum 10 onto the intermediary transfer member, and then the toner images are secondary-transferred altogether onto the transfer sheet.

### [Developer]

The developing apparatus 1 uses a developer (two component developer) containing negative charging property toner particles (non-magnetic) and positive charging property carrier particles (low magnetization high resistance). The two component developer used in this embodiment will be described.

The toner comprises binder resin such as styrene resin material, polyester resin material, and a coloring material such as carbon black, dye or pigment, and if necessary coloring resin material particles including an additive, coloring particles an externally added by material such as fine colloidal silica particles. In this embodiment, it is polyester resin material having a negative charging property, and a volume average particle size thereof is 7.0 μm.

The volume average particle size of the toner has been measured using the following method and device. A Coulter counter TA-II (available from Coulter Electronics Inc.) is used as a measuring device which is connected with a personal computer through an interface (available from Nikkaki) for outputting a number average distribution and a volume average distribution. As electric field aqueous solution, 1% sodium chloride (NaCl) aqueous solution made from first class sodium chloride is used. The measuring method for the volume average particle size of the toner is as follows. First, 0.1 ml of surfactant, preferably alkylbenzenesulfonate is added as dispersion material in 100-150 ml of the electric field aqueous solution. Then, 0.5-50 mg of the toner (measured sample) is added. The toner is dispersed by an ultrasonic dispersing device for about 1-3 minutes. After the dispersion process, by the Coulter counter TA-II using a 100 μm aperture, a particle size distribution of the particles of 2-40 μm, and a volume average distribution is determined. Using of the volume average distribution thus acquired, a volume average particle size of the toner is determined.

As for the material for the carrier particles, a metal such as surface oxidized or un-oxidized iron, nickel, cobalt, manganese, chromium rare earth, and an alloy thereof, and oxide ferrite are preferably usable. The manufacturing method of the magnetic particles is not limited to a particular one. The volume average particle size of the carrier is preferably 20-60 μm and further preferably 30-50 μm. The resistivity of the carrier is preferably not less than 10̂7 Ωcm, and further preferably 10̂8 Ωcm. In this embodiment, magnetic carrier particles having a volume average particle size of 40 μm, a resistivity of 5×10̂8 Ωcm, a magnetization amount of 260 emu/cc.

The resistivity of the magnetic carrier is measured by a method in which one of electrodes is pressed and is supplied with a voltage, and the resistivity is acquired on the basis of the current at this time. More specifically, the use is made with a sandwich type cell with which a measuring electrode area is 4 cm, and inter-electrode clearance is 0.4 cm, and a load of 1 kg it applied to one of the electrodes, and a voltage E (V/cm) is applied between the electrodes. The volume average particle size of the magnetic carrier is measured using a laser diffraction equation particle size distribution measuring device HEROS (available from Nippon Denshi Kabushiki Kaisha). In the measuring, a range of 0.5-350 μm of volume reference particle size is logarithmically divided into 32 parts, and particle numbers in the respective measurement channels are measured. From the measurement results, a median diameter of 50% volume is taken as a volume average particle size of the magnetic carrier.

The magnetic property of the magnetic carrier articles as measured using a vibration magnetic field magnetic automatic property recording device BHV-30 available from Riken Denshi Kabushiki Kaisha, Japan. As for the magnetic characteristic value of the carrier powder, external magnetic fields of 795.7 kA/m and 79.58 kA/m are produced, and magnetization intensities of the magnetic carrier are obtained. More particularly, a measurement sample of the magnetic carrier is field in a cylindrical plastic resin material container and is sufficiently packed. In the state, a magnetization moment is measured, and the actual weight of the filled magnetic carrier is measured, so that the intensity (emu/g) of the magnetization is determined. A true specific gravity of the magnetic carrier particles measured using the device such as a dry type automatic density meter ACCUPIC 1330 (available from SHIMAZU SEISAKU SHO). By multiplying the acquired intensity of the magnetization by the true specific gravity of the magnetic carrier particle, the intensity of the magnetization of the magnetic carrier per unit volume can be determined.

### [Developing Apparatus]

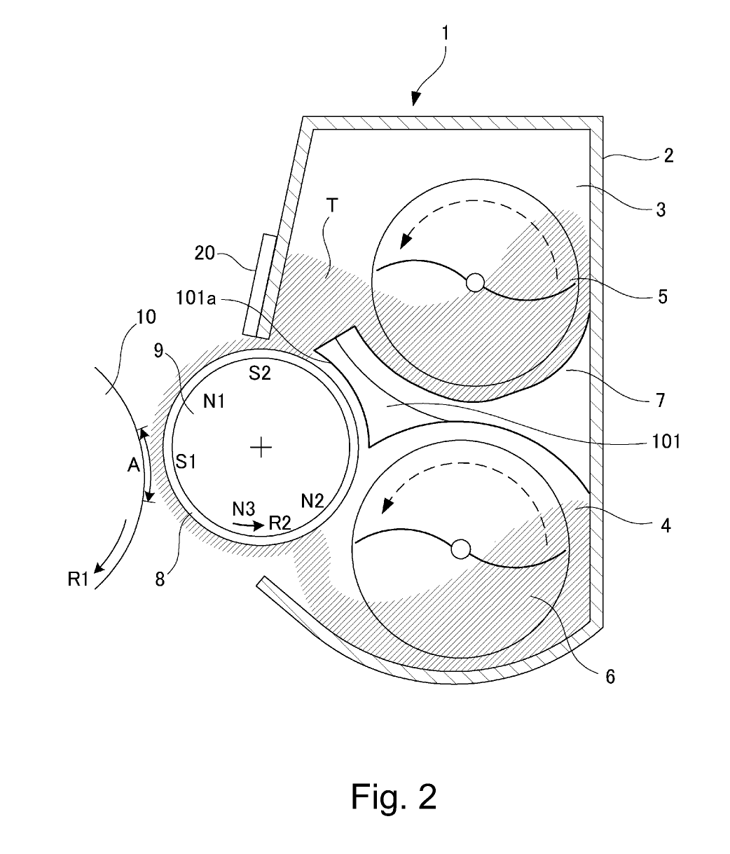

The developing apparatus 1 of Embodiment 1 will be described. The developing apparatus 1 shown in FIG. 2 is a vertical stirring type and function separating type developing apparatus. The developing apparatus 1 comprises a developing container 2, a developing sleeve 8 as a developer carrying member and a regulating blade 20 as a layer thickness regulating member. The developing container 2 accommodates a two component developer containing non-magnetic toner and magnetic carrier particles. The inside space of the developing container 2 is divided into an upper stage developing chamber 3 and a lower stage stirring chamber 4 by a partition 7 extending vertically substantially at the central portion. The developing chamber 3 and the stirring chamber 4 are in fluid communication with each other at opposite end portions to constitute a circulation path for the developer.

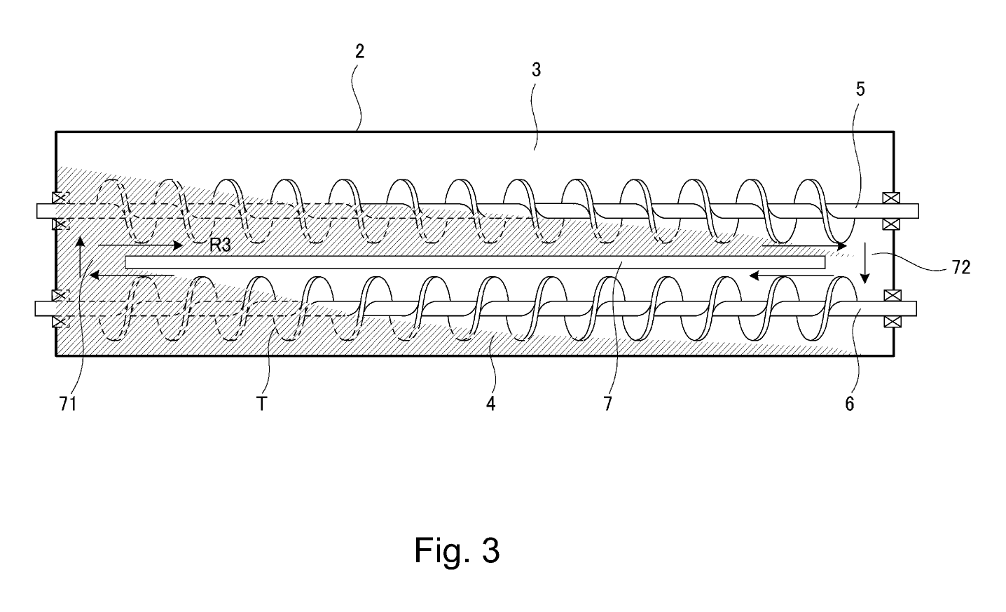

As shown in FIG. 3, the developing chamber 3 and the stirring chamber 4 are provided with a rotatable first feeding screw 5 and a rotatable second feeding screw 6 as feeding means, respectively. By the rotations of these feeding screws 5, 6, the developer T it circulated in the developing container 2 while being stirred. With the stirring of the developer T, the toner is charged to the negative polarity and the carrier is charged to the positive polarity. The feeding screw 5 (so-called development screw) is extended substantially in parallel with a rotational axis of the developing sleeve 8 in the developing chamber 3, and the feeding screw 6 (so-called stirring screw) is extended substantially in parallel with the feeding screw 5 in the stirring chamber 4. When the feeding screw 5 rotates, the developer T in the developing chamber 3 is fed unidirectionally along the rotational axis of the feeding screw 5 from the left-hand side to the righthand side in FIG. 3. On the other hand, when the feeding screw 6 rotates, the developer T in the stirring chamber 4 is fed unidirectionally along the rotational axis of the feeding screw 6 in the opposite direction, that is, from the right-hand side to the left-hand side in FIG. 3. In this manner, the developer T fed by the rotations of the feeding screws 5, 6 circulate between the developing chamber 3 and the stirring chamber 4 in the direction indicated by an arrow R3 through the communicating portions 71, 72 provided at the opposite end portions of the partition 7.

The feeding screws 5, 6 have a screw structure including a spiral stirring blade of non-magnetic material extending around the rotational shaft. The screw diameters of the feeding screws 5, 6 are 20 mm all over the axis, and the screw pitches are 30 mm. The rotational frequencies of the feeding screws 5, 6 are 600 rpm during the stirring/feeding operation.

Referring back to FIG. 2, the developing sleeve 8 is rotatably provided in the developing container 2 with a part thereof is exposed through the opening provided in the wall of the developing container 2 a position opposed to the photosensitive drum 10. The developing sleeve 8 you as in this embodiment has a diameter of 20 mm, and the photosensitive drum 10 has a diameter of 80 mm, wherein the gap between the developing sleeve 8 and the photosensitive drum 10 at the position where they are closest is approx. 300 μm. With these settings, the toner image can be developed in the state that the developer carried on the developing sleeve 8 is in contact with the photosensitive drum 10. The developing sleeve 8 is cylindrical and is made of non-magnetic material such as aluminum, stainless steel or the like, and a magnet roller 9 as magnetic field generating means is provided therein.

The magnet roller 9 has a developing pole S1 and developer feeding magnetic poles S2, N1, N2 and N3. Here, the developing pole S1 is disposed opposed to the photosensitive drum 10 in a developing zone A, and the magnetic pole S2 is disposed opposed to the regulating blade 20. Between the magnetic pole S1 and S2, the magnetic pole N1 is disposed in, and the magnetic pole N2 as disclosed upstream of the magnetic pole S2 with respect to the rotational moving direction of the developing sleeve, and in addition, the magnetic pole N3 is disposed downstream of the magnetic pole S1 with respect to the rotational moving direction. The magnetic pole N2 and the magnetic pole N3 having the same magnetic polarity are disposed adjacent to each other, and therefore, a repelling magnetic field is formed between the magnetic poles. By the repelling magnetic field, the developer it is separated from the surface of the developing sleeve, and the separated developer is collected into the stirring chamber 4.

By the magnetic forces of these magnetic poles, magnetic chains of the developer are formed on the surface of the developing sleeve. The layer thickness of the magnetic chains is regulated by the regulating blade 20 and then fed to the developing zone A. The regulating blade 20 is a plate-like member of non-magnetic material such as aluminum, and the extended in the longitudinal direction of the developing sleeve 8 at a position upstream of the photosensitive drum 10 with respect to the rotational direction of the developing sleeve. By adjusting the gap between the surface of the developing sleeve and the free end of the regulating blade 20, a chain cutting amount of the magnetic chains formed on the surface of the developing sleeve is regulated, so that the amount of the developer fed into the developing zone A is adjusted. In this embodiment, the regulating blade 20 regulates the coating amount per unit area on the developing sleeve at 30 mg/cm̂2.

The developing sleeve 8 rotates in the same peripheral moving direction (arrow R2) as the photosensitive drum 10 opposed thereto, while cowering the developer regulated by the chain cutting of the regulating blade 20, and carries the developer into the developing zone A. A peripheral speed ratio of the developing sleeve 8 to the photosensitive drum 10 is 1.75-times, for example. The peripheral speed ratio is preferably 0.5-2.5-times, and further preferably 1.0-2.0-times. With the increase of the peripheral speed ratio, the development efficiency increases, but if it is too large, the problems of the toner scattering and the developer deterioration or the like may arise, and therefore, the preferable range is 1.0-2.0-times.

In the developing zone A, the free ends of the magnetic chains rub the surface of the photosensitive drum 10 to supply the developer to the electrostatic latent image formed on the photosensitive drum 10, thus developing the electrostatic latent image into a toner image. At this time, in order to improve the development efficiency, that is, an application rate of the toner to the electrostatic latent image, the developing sleeve 8 is supplied with a developing bias voltage which is in the form of a DC voltage component plus an AC voltage component. For example, it is an oscillating voltage comprising a DC voltage component of −500V and a rectangular AC voltage component having a peek-to-the voltage of 800V and a frequency of 12 kHz. The DC voltage value, the AC voltage and the waveform described above are not restrictive to the present invention. When an AC voltage is superimposed, the development efficiency rises to provide high quality of the image, on the contrary white background fog tends to occur. In order to prevent the fog, it is preferable to provide a potential difference between the DC voltage applied to the developing sleeve 8 and in the charged potential Of the photosensitive drum 10 (white background portion potential).

### [End Portion Seal Structure]

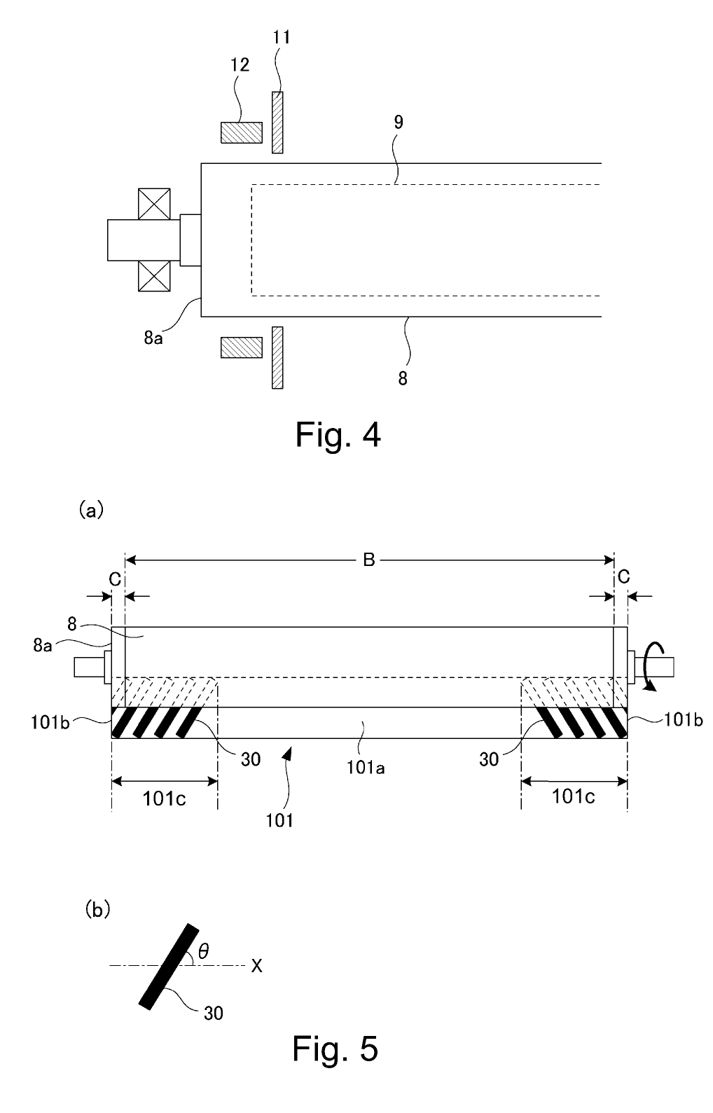

The opposite end portions of the developing sleeve 8 are sealed. A sealing structure used in this embodiment is a magnetic seal structure for magnetically blocking between the outside and the inside of the developing container 2. FIG. 4 shows an example of the magnetic seal structure. The shown in FIG. 4 comprises a plate-like magnetic plate 11 and a magnet sheet 12 disposed adjacent to an end portion 8a of the developing sleeve 8 which has not been subjected to a surface roughing treatment. The magnetic plate 11 covers a part of the developing sleeve 8 without contact thereto along an outer periphery of the developing sleeve 8 in the developing container 2. A magnetic force is produced between the magnetic plate 11 and the magnet roller 9 inside the developing sleeve 8, and therefore, the developer between the magnetic plate 11 and the developing sleeve 8 is formed into magnetic chains. The magnetic chains fill in the gap to prevent the developer leakage from the sleeve end portion 8a.

If there is a region with respect to the circumferential direction of the magnet roller 9, when the magnetic force is weak, the magnetic force produced between the magnetic plate 11 is weak in such a region, and the magnetic force lines are sparse. Then, the magnetic chains and not dense as compared with the other region, and therefore, the developer leakage tends to occur. In this embodiment, the magnetic force lines are sparse in the region between the magnetic poles N2 and N3 having the same polarity and disclosed adjacent to each other in the magnet roller 9. Therefore, despite the provision of the magnetic plate 11, the developer leakage from the region between the magnetic poles N2 and N3 tends to occur.

To avoid this problem, a magnet sheet 12 is provided outside (end portion 8a side) the magnetic plate 11 with respect to a rotational axis direction of the developing sleeve 8. The magnet sheet 12 retains by the magnetic force the developer leaked from between the magnetic plate 11 and in the developing sleeve 8. The magnet sheet 12 is effective to produce magnetic force lines between the magnetic plate 11, and form magnetic chains between the magnet sheet 12 and the magnetic plate 11 to fill the gap. In this manner, the developer leakage from the end portion 8a of the sleeve can be effectively suppressed, by the provision of the magnet sheet 12 in addition to the magnetic plate 11.

However, the amount of the developer which the magnetic plate 11 and in the magnet sheet 12 can retain is limited, and therefore, they become incapable of retaining the developer sooner or later. In addition the magnetic seal structure using the magnetic chains does not closely sealed the developing container 2, and the developer leakage is not completely prevented. For example, if the magnetic chains are pushed by a force exceeding the magnetic forces of the magnetic plate 11 and the magnet sheet 12, the developer constituting the magnetic chains is pushed out of the magnetic plate 11 and the magnet sheet 12 with the result of developer leakage (peel off). Thus, it is difficult to effectively prevent the developer leakage only by the magnetic seal structure.

### [Dragging Reducing Member]

As shown in FIG. 3, the height of the developer T circulated in the developing chamber 3 and the stirring chamber 4 gradually increases from the communicating portion 72 toward the communicating portion 71. This is because the developer T removed from the developing sleeve 8 and then collected into the stirring chamber 4 merges with the existing developer T fed by the feeding screw 6 in the stirring chamber 4. Furthermore, this is caused by the developer T lifted from the stirring chamber 4 into the developing chamber 3 in the communicating portion 71 side As a result of the amount of the developer T larger in the communicating portion 71 side, the surface level of the developer T can increase beyond the necessity adjacent to thee communicating portion 71. Then, the developer T supplied to the developing sleeve 8 in the stirring chamber 4, and undesirably large amount of the magnetic chains is formed on the developing sleeve 8, with the result that the developer is dragged on the developing sleeve 8.

According to the developing apparatus 1 of Embodiment 1, even if the surface level of the developer in the stirring chamber 4 increases beyond the necessity, the dragging of the developer is suppressed by the provision of the reducing member 101. The dragging reducing member 101 is provided on the regulating blade 20 at the upstream side with respect to the rotational direction of the developing sleeve 8, more particularly on such a surface of the partition 7 for partitioning between the developing chamber 3 and the stirring chamber 4 as is opposed to the developing sleeve 8. The gap between the developing sleeve 8 and the dragging reducing member 101 is narrower than the length of the magnetic chains when the dragging by the developing sleeve 8 occurs. Therefore, the magnetic chain that is the carried developer when the dragging occurs is limited by the reducing member 101, and therefore, it is difficult to drag the developer from the N2 pole position to the S2 pole of the magnet roller 9.

The reducing member 101 would not properly function unless it is contacted to the carried developer when the developer is dragged. The inventors have confirmed that without the provision of the reducing member 101 in order to intentionally produces the dragging of the developer, the thickness of the developer carrying on the developing sleeve 8 is approx. 1 mm. Therefore, the distance between the reducing member 101 and in the developing sleeve 8 is set to 800 μm so that the reducing member 101 necessarily contacts with the developer to limit it. The length of the reducing member 101 measured in the longitudinal direction may be the same as or longer than the length of the developing sleeve 8 measured in the longitudinal direction so that the developer can be limited all over the length of the developing sleeve 8 (FIG. 5).

When the mixing ratio of the toner to the carrier during the operation of the developing apparatus 1 changes or when the toner charge amount changes as a result of the change of the temperature and/or humidity, the bulk density and/or the feeding performance of the developer changes. In addition, when the image formation with low consumption of the toner is carried out for a long term, the agglomerativeness of the developer change is with the result of the change in the bulk density and/or feeding performance of the developer. When the unintentional change of the bulk density and/or feeding performance of the developer occurs, the surface level of the developer adjacent to the communicating portion 71 of the stirring chamber 4 may be higher than in the normal condition. When the surface level of the developer increases, a simple reducing member (without a groove 30 which will be described hereinafter) does not properly prevent the dragging of the developer. Therefore, the developer leakage may occur from the end of the sleeve.

On the basis of the foregoing analysis, according to Embodiment 1, the dragging reducing member 101 is provided with a guiding portion in the form of a groove 30 in order to prevent the developer leakage attributable to the movement of the developer adjacent to the end portion of the sleeve and in order to prevent the developer leakage attributable to the dragging. Referring to FIG. 5, the reducing member 101 will be described. The reducing member 101 shown in part (a) of FIG. 5 is provided with a plurality of grooves 30 on the surface 101a opposing the developing sleeve 8 in a predetermined range from the end portion 101b (groove region 101c in the Figure). The groove region 101c covers a sleeve end portion side including a boundary portion between a carrying region B where the developing sleeve 8 spaced therefrom carries the developer and a non-carrying region C where the developing sleeve 8 does not carry the developer. As shown in part (b) of FIG. 5, the grooves 30 are inclined by a predetermined angle θ (inclination angle) relative to the rotational axis X of the developing sleeve 8 and are parallel with each other at regular intervals. In addition, the grooves 30 extend such that one end portions are close to the end portion 101b in the upstream the (lower side in part (a) of FIG. 5) with respect to the rotational moving direction of the developing sleeve 8, and such that the other end portions are remote from the end portion 101b in the downstream side (upper portion in part (a) of FIG. 5) with respect to the rotational moving direction.

By the provision of the grooves 30 in the groove region 101c of the dragging reducing member 101, the developer is guided from the sleeve end portion toward the central portion of the sleeve with the rotation of the developing sleeve 8. Thus, the reducing member 101 is capable of limiting the developer directed by the rotating developing sleeve 8. The developer moved by the developing sleeve 8 is dragged from the lower portion of the upper portion in FIG. 5 with the rotation of the developing sleeve 8 and enter the region under the reducing member 101. In the developer is then pushed further upwardly with the rotation of the developing sleeve 8. At this time, in the groove region 101c, the pushed developer receives a force along the grooves 30 toward the central portion of the sleeve. By the force toward the central portion of the sleeve, the force tending to move the developer toward the sleeve end portion is reduced. For this reason, the developer is less leaked at the end portion 8a of the sleeve. In this manner, the groove 30 in the groove region 101c guide the developer dragged by the developing sleeve 8 from the sleeve end portion 8a toward the central portion of the sleeve with the rotation of the developing sleeve 8, thus reducing the developer leakage from the sleeve end portion 8a

The inclination angle θ is selected so that the effect of guiding the developer from the end portion to the central portion. If the inclination angle relative to the rotational axis X of the developing sleeve 8 is too large or too small, the force tending to move the developer toward the central portion of the sleeve is weak. For example, if the inclination angle θ=90°, that is, the grooves 30 are perpendicular to the rotational axis X of the developing sleeve 8, no force toward the central portion of the sleeve is produced, and therefore, the developer does not move toward the central portion of the sleeve. On the other hand, if the inclination angle θ=0°, that is, the grooves 30 extend in parallel with the rotational axis X of the developing sleeve 8, the force toward the central portion is produced, and therefore, the developer moves toward the central portion. However, in this case, the developer moving toward the central portion merges with the developer dragged by the developing sleeve 8 outside the groove region 101c. Upon the merging, the developer receives a significant reaction force, and as a result, the developer leakage from the sleeve end portion occurs. In view of the foregoing, it is preferable that the inclination angle θ of the grooves 30 is 30°-60°, more particularly, approx. 45° in order to provide efficiently the force guiding the developer toward the central portion of the sleeve and to efficiently change the moving direction of the developer.

### Comparison Example of Embodiment 1

The developer leakage from the sleeve end portion in a comparison example and Embodiment 1 have been checked. In the checking, the reducing member 101 is provided with grooves 30 having a deep of 100 μm and a width of 200 μm a range at intervals of 200 μm. The inclination angle of the grooves 30 is 45°. Continuous printing operations corresponding to 200000 sheets are carried out, and the leakage is checked. When leakage is observed, the leakage from the neighborhood of the regulating blade mainly attributable the dragging of the developer and the end portion leakage mainly attributable to the movement of the developer in the neighborhood of the sleeve end portion are checked, respectively. Table 1 shows the results of comparison. In comparison examples 1-3, no groove 30 is formed on the reducing member 101.

TABLE 1

| | Conditions | | | | |
|---|---|---|---|---|---|
| | Grooves | | Grooves | Result of leakage | |
| | at | | of | Around | |
| | sleeve | Reducing | reducing | regulating | Sleeve |
| | ends | members | members | blade | ends |
| Comp. | No | No | No | Yes | Yes |
| Ex. 1 | | | | | |
| Comp. | No | Yes | No | No | Yes |
| Ex. 2 | | | | | |
| Comp. | Yes | Yes | No | Yes | Slight |
| Ex. 3 | | | | | |
| Emb. | No | Yes | Yes | No | No |
| 1 | | | | | |

In comparison example 1, no reducing member 101 is provided, and no groove is formed at any of the opposite end portions of the developing sleeve 8. Here, the structure in which no groove is formed at any of the opposite end portions of the developing sleeve 8 means that no groove is provided at least in the neighborhood of the opposite end portions of the developing sleeve 8, although grooves may be provided on the other portions. In comparison example 1, both of the leakage from the neighborhood of the regulating blade and the end portion leakage were observed at the time when 50000 sheets were processed. The reason for this is as analyzed hereinbefore. In comparison example 2, a reducing member 101 without groove is mounted, and no groove is formed at any of the opposite end portions of the developing sleeve 8. According to comparison example 2, the amount of the developer dragged on the developing sleeve 8 could be significantly reduced by the reducing member 101, and as compared with comparison example 1, the leakage prevention from the neighborhood of the regulating blade was improved. However, with the continuous operation, the end portion leakage gradually appeared. This is because the magnetic sealing member (11, 12) becomes incapable of retaining the developer. In comparison example 3, a reducing member 101 without groove is mounted, and grooves are formed at the opposite end portions of the developing sleeve 8. In comparison example 3, the amount of the end portion leakage was relatively small, but the leakage from the neighborhood of the regulating blade was observed from an early stage of the test. The reason why the end portion leakage reduced in the comparison example 2 is suppressed in comparison example 3 is that the grooves formed at the opposite ends of the developing sleeve 8 gradually pushes the developer back to the central portion from the end portions of the developing sleeve 8.

The reason why the leakage from the neighborhood of the regulating blade occurs in the comparison example 3 will be described. In the neighborhood of the regulating blade, the regulated developer forms developer stagnation in the pressurized state in a certain degree. Therefore, the developer limited by the regulating blade 20 tends to move toward the sleeve end portions. However, even in the neighborhood of the regulating blade, the developer moved to the sleeve end portions is retained by the magnetic sealing members, and therefore, does not quickly leak. The developer retained by the magnetic sealing members (11, 12) forms magnetic chains extending along the magnetic force lines. The magnetic chains fill the gap between the developing sleeve 8 and the developing container 2 to block the developer tending to move toward the sleeve the. Here, in comparison examples 1 and 2, no groove is formed at any of the opposite end portions of the developing sleeve 8, and therefore, the developer formed into the magnetic chains by the magnetic sealing member (11, 12) is not moved by the movement of the developing sleeve 8. In other words, it does not occur that a part of the magnetic chains separates from the magnetic sealing member (11, 12), as will be described hereinafter. Therefore, in comparison example 2, the magnetic chains keep blocking the developer tending to move to the sleeve end portion without exchange of a part, and therefore, the leakage from the neighborhood of the regulating blade is not produced.

On the other hand, in comparison example 3, the grooves are formed at the opposite end portions of the developing sleeve 8, and therefore, a force of moving the developer in the rotational direction of the developing sleeve 8 wherein the rotation of the developing sleeve 8 is produced at each of the opposite end portions of the developing sleeve 8. When this force is produced, a part of the developer formed into the magnetic chains by the magnetic sealing member (11, 12) may separate from the magnetic chains. Particularly, at the position of the magnet roller 9 substantially opposing the regulating blade 20, it is ordinarily that a cutting pole (S2 pole in Embodiment 1) for the purpose of standardizing the developer amount (coating amount) carried by the developing sleeve 8. By the cutting pole S2, magnetic chains extending from the magnetic sealing member (11, 12) toward the developing sleeve 8 are formed at the sleeve end portion adjacent to the regulating blade. The magnetic chain is easily influenced by the force developer in the rotational direction of the developing sleeve 8, and therefore, a part of the developer forming the magnetic chains separates from the magnetic chains with the rotation of the developing sleeve 8. The developer having separated from the magnetic chains move in the rotational direction of the developing sleeve 8 with the rotation of the developing sleeve 8, and leaks out of the developing container 2 through the gap between the regulating blade 20 and the developing sleeve 8.

To the magnetic chains having lost the part of the developer, the developer limited by the regulating blade 20 quickly moves to supplement the lost developer. Thus, in the sleeve end portions, a part of the developer forming the magnetic chains is moved with the rotation of the developing sleeve 8, and the new developer substitutes, and this is repeated. Such an exchange of the developer on the magnetic sealing member (11, 12) partly causes the leakage from the neighbor first of the regulating blade. Therefore, the developer leakage from the neighborhood of the regulating blade is continuously repeated. The reason why the grooves are provided at the opposite end portions of the developing sleeve 8 is to gradually move the developer back to the central portion from the end portions. However, particularly in the neighborhood of the regulating blade, the developer capable of moving nowhere is successively supplied, and therefore, the intended effect of the grooves does not effectively function, with the result of successive leakage. In this manner, in comparison example 3, the leakage in the neighborhood of the regulating blade occurs despite the mounting of the dragging reducing member 101.

On the contrary to the comparison examples 1-3, in Embodiment 1, both of the leakage from the neighborhood of the regulating blade and the end portion leakage were prevented (Embodiment 1 in Table 1). This is because of the provisions of the grooves 30 on the dragging reducing member 101 which is a non-rotatable member, not on the developing sleeve 8 which is a rotatable member, in Embodiment 1. In addition, this is also because of the formation of the grooves 30 in the groove regions 101c adjacent to the sleeve end portions including the carrying regions B and in the non-carrying regions C. More particularly, the reducing member 101 reduces the amount of the developer dragged by the developing sleeve, by which the pressure applied to the developer stagnation adjacent to the regulating blade is reduced. In addition, the dragged developer is positively pushed back from the sleeve end portions toward the central portion, and therefore, a high-pressure is avoided in the developer stagnation adjacent to the sleeve end portions, which immediately leads to the developer leakage. If the opposite end portions of the developing sleeve 8 has not been treated for surface roughening, the leakage from the neighborhood of the regulating blade as in comparison example 3 does not result. In this manner, in Embodiment 1, the leakage from the neighborhood of the regulating blade does not occur.

In addition, if the developer moves to the sleeve end portion with the rotation of the developing sleeve 8, such a developer is pushed back toward the central portion from the sleeve end portion by the grooves 30, and therefore, the end portion leakage does not occur, either, in Embodiment 1. Furthermore, since the dragging reducing member 101 does not rotated, the reducing member 101 per se does not produce the force tending to move the developer to the end portions. Therefore, no force is produced against the pushing-back force, and therefore, the developer can be returned to the central portion from the sleeve end portions.

As described in the foregoing, according to Embodiment 1, the dragging reducing member 101 is provided with the grooves 30. By this, the developer leakage (end portion leakage) attributable to the movement of the developer adjacent to the end portions of the developing sleeve can be suppressed. In addition, the developer leakage (leakage from the neighborhood of the regulating blade) attributable to the increase of the pressure applied to the developer can be suppressed, too.

### Embodiment 2

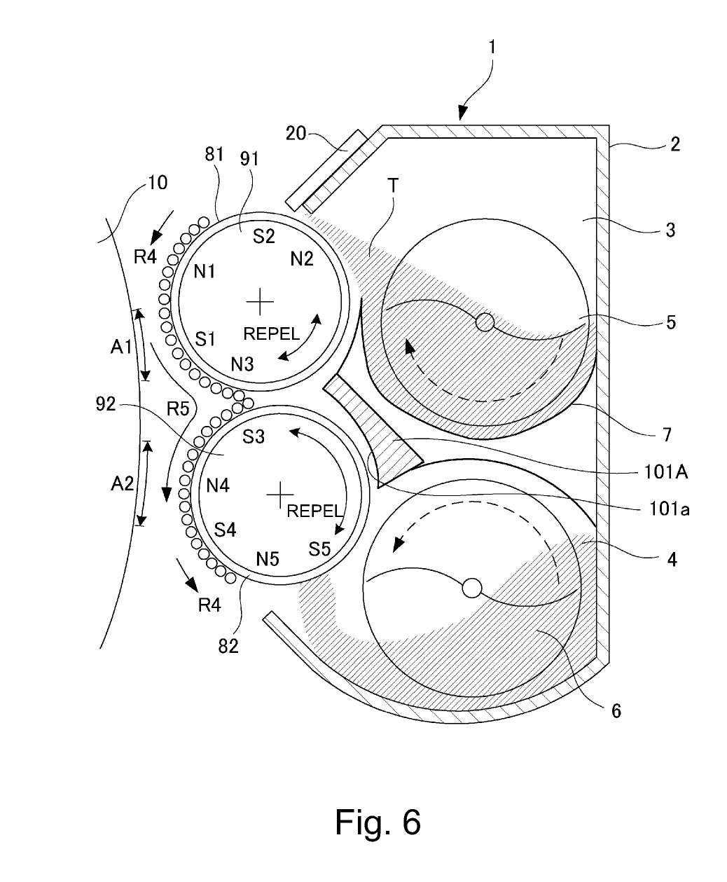

FIG. 6 is a sectional view illustrating a structure of the developing apparatus according to Embodiment 2. In the developing apparatus of Embodiment 2, the plurality of current image bearing members (two in this example) are provided vertically are provided, and the dragging reducing members 101A are mounted similarly to Embodiment 1. In the description of this embodiment, the same reference numerals as in Embodiment 1 are assigned to the elements having the corresponding functions in this embodiment, and the detailed description thereof is omitted for simplicity.

As shown in FIG. 6, in the developing apparatus 1 of Embodiment 2, a magnet roller 91 as first magnetic field generating means is non-rotatably provided in the upstream developing sleeve 81 as a first developer carrying member. The upstream developing sleeve 81 is made of non-magnetic material, and is rotatable in the direction indicated by an arrow R4 and calories the developer. Above the upstream developing sleeve 81, a regulating blade 20 as a layer thickness regulating member is provided. The magnet roller 91 has a magnetic pole N2 adjacent to the position opposing to the regulating blade 20. Also in the developing apparatus 1 of Embodiment 2, a developer stagnation pressurized to a certain degree is formed adjacent to the regulating blade. This is because the developer stagnates by being confined by the magnetic force of the magnetic pole N2 in the neighborhood of the regulating blade and because the stagnating developer is regulated into a proper layer thickness by the regulating blade 20. After the developer is regulated into the proper layer thickness, the developer is fed into the first developing zone A1 for the photosensitive drum 10 by the upstream developing sleeve 81.

The magnet roller 91 is provided with a developing pole S1 at a position opposing to the first developing zone A1. The developing pole S1 forms magnetic chains on the surface of the upstream developing sleeve 81 positioned so as to be opposed the first developing zone A1. The magnetic chains formed at the position opposing to the first developing zone A1 contact to the photosensitive drum 10 to develop the electrostatic latent image on the photosensitive drum 10 into a toner image. At this time, the toner deposited on the surface of the upstream developing sleeve 81 as well as the toner deposited on the magnetic chains are supplied to the electrostatic latent image to be used for the development.

The magnet roller 91 has 5 magnetic poles S1, S2, N1, N3, and N2. Among these magnetic poles, the poles N2 and N3 having the same polarity of adjacent to each other, and therefore, a repelling magnetic field is formed between these magnetic poles. By the repelling magnetic field, a barrier against the developer is provided.

Below the upstream developing sleeve 81, a downstream developing sleeve 82 as second developer carrying means is provided so as substantially to oppose both to the upstream developing sleeve 81 and the photosensitive drum 10, and the downstream developing sleeve 82 is rotatable in the direction indicated by an arrow R4 (the same rotational moving direction as of the upstream developing sleeve 81). The downstream developing sleeve 82 is made of non-magnetic material similarly to the upstream developing sleeve 81, and a magnet roller 92 is provided non-rotatably as second magnetic field generating means therein. The magnet roller 92 is provided with 5 magnetic poles S3, N4, S4, N5 and S5.

The magnetic pole N4 forms magnetic chains on the surface of the downstream developing sleeve 82 disposed opposed to the second developing zone A2. By the magnetic chains formed by the magnetic pole N4 contacting to the photosensitive drum 10 in the second developing zone A2, the electrostatic latent image on the photosensitive drum 10 having passed through the first developing zone A1 is secondarily developed. The magnetic poles S3 and S5 are disposed adjacent to each other, and a barrier against the developer formed by the repelling magnetic field between the magnetic poles. The magnetic pole S3 is disposed so as to substantially to oppose to the magnetic pole N3 in the magnet roller 91 adjacent to the position closest to the upstream developing sleeve 81.

Flow of the developer in the developing apparatus 1 of Embodiment 2 will be described. The developer is carried on the upstream developing sleeve 81 and said in the order of N2-S2-N1-S1-N3. Thereafter, the developer on the upstream developing sleeve 81 is passed onto the downstream developing sleeve 82. As described in the foregoing, the repelling magnetic field is formed between the magnetic poles N3 and N2 of the upstream developing sleeve 81, and also, the repelling magnetic field is formed between the magnetic poles S3 and S5 of the downstream developing sleeve 82. The developer on the upstream developing sleeve 81 fed to the magnetic pole N3 is blocked by the barriers formed by the repelling magnetic fields so as not to enter between the sleeves 81 and 82. The blocked developer move in the direction indicated by an arrow R5 from the upstream developing sleeve 81 to the downstream developing sleeve 82 along the magnetic force lines extending from the magnetic pole N3 to the magnetic pole S3 which are disposed substantially opposed to each other. The developer moved to the downstream developing sleeve 82 is fed by the downstream developing sleeve 82 in the order of S3-N4-S4-N5 and S5. When the developer on the downstream developing sleeve 82 reaches the magnetic pole S5 position, the developer is blocked by the repelling magnetic field between the magnetic poles S5 and S3, so that the developer is scraped off from the downstream developing sleeve 82 and is collected into the stirring chamber 4.

The developer passing magnetic poles N3 and S3 are not necessarily opposed to each other exactly. This is because, if they are opposed within the range of 45° from the exact opposing position, the developer can be passed smoothly from the upstream developing sleeve 81 to the downstream developing sleeve 82.

The developer leakage from the sleeve end portion at the time of the developer dragging is more likely to occur in the developing apparatus comprising two developing sleeves than in the developing device comprising only one developing sleeve. Referring to FIG. 6, the developer leakage when the developer dragging occurs on the downstream developing sleeve 82 in the developing apparatus comprising two developing sleeves.

The developer dragging on the downstream developing sleeve 82 merges with the magnetic chains on the upstream developing sleeve 81 or downstream developing sleeve 82 adjacent to the position where the magnetic pole N3 in the upstream developing sleeve 81 and the magnetic pole S3 in the downstream developing sleeve 82 are opposed. However, a regulating force to the developer by the magnetic chains is much stronger than the regulating force of the regulating blade 20, and therefore, the dragged developer is snapped by the magnetic chains toward the sleeve end portions. Therefore, the dragging developer all leaks from the sleeve end portions without merging with the magnetic chain. Here, when only one developing sleeve is provided, only a part of the developer remitted by the regulating blade 20 leaks from the end portion of the sleeve, and the other developer is accommodated in the developing chamber 3. As will be understood, in the case of the developing device comprising two developing sleeves, the developer leakage from the sleeve end portions may be greater than in the case of the developing device comprising only one developing sleeve.

In view of this, it would be considered that the dragging reducing members are provided in the developing apparatus comprising two developing sleeves. As shown in FIG. 6, the reducing member 101A provided opposed to the downstream developing sleeve 82 at the partition 7 partitioning the developing container 2 between the developing chamber 3 and the stirring chamber 4. With such positioning of the reducing member 101A, the amount of the developer dragged by the downstream developing sleeve 82 can be reduced. This is because the amount of the developer which is moved to the neighborhood of the opposing position between the magnetic pole N3 in the upstream developing sleeve 81 and the magnetic pole in the downstream developing sleeve 82 and then snapped by the magnetic chains can be reduced. However, by simply providing a known reducing member, the developer leakage from the end portions of the sleeves could not be prevented (comparison example 4 of Table 2 hereinafter).

In view of this fact, in the developing apparatus 1 according to Embodiment 2, grooves 30 similar to those of Embodiment 1 are provided on the surface 101a of the reducing member 101A opposing to the downstream developing sleeve 82. Here, the structures having been described with respect to the reducing member 101A in Embodiment 1 are all applicable to the developing apparatus 1 of Embodiment 2.

### Comparison Example of Embodiment 2

The developer leakage from the sleeve end portion in a comparison example and Embodiment 2 has been checked. The configurations of the grooves 30 and the checking method are the same as those in Embodiment 1. Table 2 shows the results of comparison. In comparison examples 4-6, no groove 30 is provided on the reducing member 101.

TABLE 2

| | Conditions | | | | | |
|---|---|---|---|---|---|---|
| | | Grooves | | | | |
| | Grooves | at | | | | |
| | at up- | down- | Grooves | Result of leakage | | |
| | stream | stream | of | Around | | Uneven- |
| | sleeve | sleeve | reducing | regulating | Sleeve | ness of |
| | ends | ends | members | blade | ends | coating |
| Comp. | No | No | No | No | Yes | No |
| Ex. 4 | | | | | | |
| Comp. | Yes | Yes | No | Yes | No | Yes |
| Ex. 5 | | | | | | |
| Comp. | No | Yes | No | No | No | Yes |
| Ex. 6 | | | | | | |
| Emb. 2 | No | No | Yes | No | No | No |

In comparison example 4, no groove is formed at either of the opposite end portions of the upstream developing sleeve 81, and no groove is formed at either of the opposite end portions of the downstream developing sleeve 82. In comparison example 4, the end portion leakage is observed due to the strong regulating force by the magnetic chains between the upstream developing sleeve 81 and the downstream developing sleeve 82. In comparison example 5, the grooves are provided at the opposite end portions of the upstream developing sleeve 81 and the downstream developing sleeve 82. In comparison example 5, no end portion leakage is observed, and from an early stage of the test, the leakage from the neighborhood of the regulating blade is observed. In comparison example 6, no groove is provided for the upstream developing sleeve 81, but the grooves are provided for the downstream developing sleeve 82. In comparison example 6, neither of the leakage from the regulating blade or the end portion leakage is observed.

However, in comparison example 5 and comparison example 6, coating unevenness appears particularly adjacent to a boundary between a developer carrying region where the developing sleep carries developer and a non-carrying region where the developing sleeve does not carry the developer. This is because the developer moves from the sleeve end portions to the central portion by the grooves provided at the opposite end portions of the upstream or downstream developing sleeve 81, 82 enters the carrying region from the non-carrying region, thus increasing the amount of the developer in the carrying region of the upstream downstream developing sleeve 81 or 82. The amounts of the developer in the carrying region have been measured, and coating amount in the central portion of the carrying region is 30 mg/cm̂2, whereas the coating amount in the boundary portion between the carrying region and the non-carrying region is 60 mg/cm̂2, which is twice that of the central portion.

On the contrary to comparison examples 4-6, in Embodiment 2, no end portion leakage is observed, and the leakage from the neighborhood of the regulating blade is observed without the provision of the groove at the opposite end portions of the downstream developing sleeve 82 and at the opposite end portions of the upstream developing sleeve 81 (Embodiment 2 in Table 2). This is because the dragging reducing member 101A is provided with the grooves 30, as has been described in Embodiment 1. In addition, it is because the grooves 30 are disposed in the groove region 101c in the sleeve end portion side. Furthermore, no coating non-uniformity is observed in the test of Embodiment 2. In the developing apparatus 1 of Embodiment 2, it is unnecessary to form the grooves as far as the end portions of the upstream developing sleeve 81 and the downstream developing sleeve 82, and therefore, the coating unevenness as with the comparison example 6 is not produced. Thus, also in the developing apparatus 1 of Embodiment 2, the effects similar to those of Embodiment 1 can be provided by the formation of the grooves 30 on the dragging reducing member 101A.

### Embodiment 3

The developing apparatus according to the present invention is not limited to the developing apparatus using a two component developer of Embodiment 1 or Embodiment 2. In a developing apparatus using a one component developer, magnetic particles contained in the toner particles are charged, and the developer is magnetically attracted to the developing sleeve. The developing apparatus using the one component developer is used for an image forming station in which a charge amount may be small, that is, the image forming station PK (FIG. 1) for forming a black toner image on the photosensitive drum in a full-color machine, an image forming station of a monochromatic machine, for example. In Embodiment 3, the apparatus is a monochromatic machine using a magnetic one component toner. FIG. 3 is a sectional view illustrating a structure of the developing apparatus according to Embodiment 3.

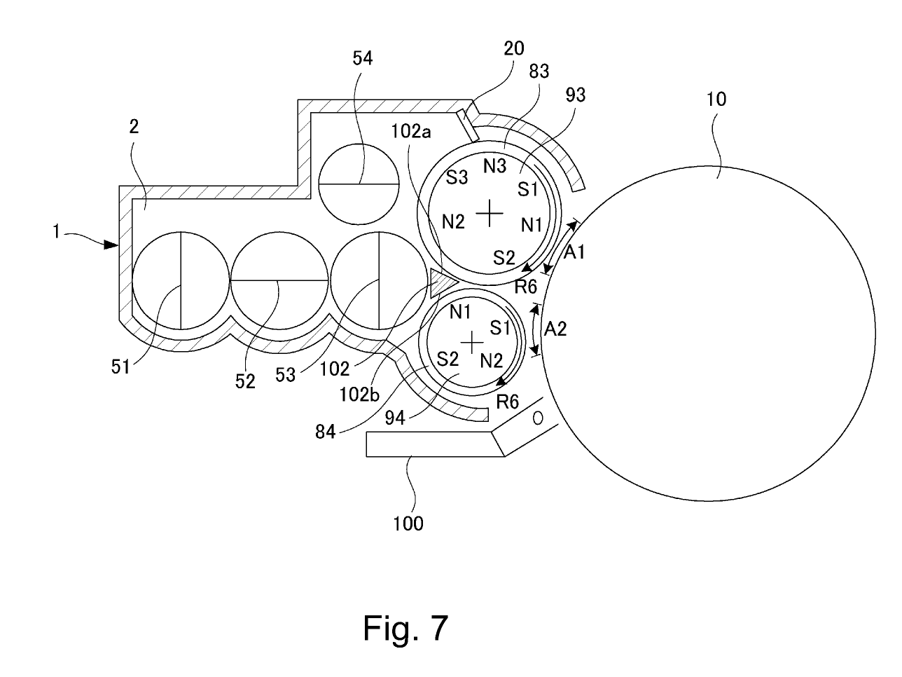

In the developing apparatus 1 of Embodiment 3 shown in FIG. 7, developing sleeves 83, 84 as first and second developer carrying members are provided opposed to a photosensitive drum 10. A gap between the upper stage developing sleeve 83 and the lower stage developing sleeve 84 at the closest position is approx. 200-400 μm. The developing container 2 is provided with an opening at a position opposing to developing zones A1, A2 of the photosensitive drum 10, and the developing sleeves 83, 84 are partly exposed through the opening. The developing sleeve 83, 84 are rotatable in the same rotational moving direction (arrow R6). At the opposite end portions of the developing sleeves 83, 84, magnetic sealing members (unshown) shown in FIG. 4 are provided. Above the upper stage developing sleeve 83, a regulating blade 20 as a layer thickness regulating member is provided. Lower the lower stage developing sleeve 84, a post charger 100 is provided. Furthermore, the developing container 2 is provided with stirring members 51, 52, 53 and 54 as feeding means.

The developing container 2 contains a magnetic one component toner as the one component developer. The magnetic one component toner used in Embodiment 3 is negative charged toner (negative charging property toner) comprising, as the base material, at least one of styrene acrylic resin material and polyester resin material. The developer particle comprises approx. 60-90 parts by weight of magnetic material, and the developer further comprises 0.5-1.5 weight percent of silicon dioxide (SiO2) as an externally added material. A weight average particle size thereof is approx. 5.0-7.5 μm, and a ratio magnetic permeability is approx. 1.5-2.0.

Each of the developing sleeves 83 and 84 comprises a cylindrical member of non-magnetic member (aluminum), and a coating film of phenolic resin, crystalline graphite and carbon mixed at a predetermined weight ratio cured under 150 degree C. ambient condition. In order to provide stabilized and uniform film, the thickness of the film is approx. 20 μm, and a ratio of the weight of the phenolic resin to the weight of the other material (crystalline graphite and carbon) is 2:1. The phenolic resin contains approx. 20 parts by weight of fourth class ammonium salt so that the charging properties of the developing sleeve 83 and the developing sleeve 84 relative to the developer are optimum. When the fourth class ammonium salt is added in the phenolic resin, it is uniformly dispersed. With heat curing of the fourth class ammonium salt, the phenolic resin becomes having a negative charging property. Using the developing sleeves 83, 84 having the film of the materials, the developer can be charged to a relatively lower voltage.

In the developing sleeves 83, 84, magnet rollers 93, 94 as first and second magnetic field generating means are non-rotatably provided, respectively. The magnet roller 93 has an even number of different polarity magnetic poles (6 poles, N1, N2, N3, S1, S2, S3) alternately to form a magnetic field pattern. The magnet roller 94 has an even number of different polarity magnetic poles (4 poles, N1, N2, S1, S2) alternately to form a magnetic field pattern. Thus, same polarity magnetic poles are not adjacent to each other. Therefore, as is different from Embodiments 1, 2, no repelling magnetic field is produced on the developing sleeves 83, 84 to developing apparatus of Embodiment 3.

The repelling magnetic field is unnecessary for the following reasons. In the case of the developing apparatus (Embodiments 1, 2) using the two component developer, when the toner is consumed by the image formation, the ratio of the magnetic carrier and the toner (TD ratio) locally decreases. Such decrease of the TD ratio may cause a density non-uniformity, and therefore, it is necessary to collect temporarily the developer having the decreased TD ratio. Under the circumstances, in the developing apparatus using the two component developer, the repelling magnetic field is necessary to scrape the developer having the decreased TD ratio off the developing sleeve and to collect it into the stirring chamber 4. In addition, in order to prevent the dragging of the developer having the decreased TD ratio, the repelling magnetic field is necessary. On the other hand, in the case of the developing apparatus using the one component developer (Embodiment 3), the decrease of the TD ratio cannot occur, and even if the dragging of the developer occurs, the problem of the density non-uniformity hardly occurs. For these reasons, in the developing apparatus using the one component developer, even number poles structure without the repelling magnetic field on the developing sleeves 83, 84 is employed.

The developer in the developing container 2 is supplied to the developing sleeves 83 while being stirred by stirring members 51, 52, 53 and 54. The developing sleeves 83 and 84 are rotated in the same direction (arrow R6). The developing sleeve 83 carries the developer with magnetic force of the magnet roller 93, and is regulated in the layer thickness thereof by the regulating blade 20. On the other hand, the developing sleeve 84 carries the developer by the magnetic force of the magnet roller 94, and is regulated in the layer thickness by the developing sleeve 83. That is, layer thickness of the developer carried on the developing sleeve 84 is regulated by the gap between the developing sleeve 83 with developing sleeve 84.

The developing sleeves 83 and 84 feed the developer into the developing zones A1, A2 to supply the toner to the electrostatic latent image formed on the photosensitive drum 10, thus developing it into a toner image. At this time, the developer carried on the developing sleeves 83 and 84 jump at the photosensitive drum 10 so that the electrostatic latent image on the photosensitive drum 10 in a non-contact fashion. More specifically, the developing sleeves 83 and 84 are supplied (from a unshown voltage source) with a developing bias voltage which is in the form of a DC voltage biased with an AC voltage having a peak-to-peak voltage of 1-2 kV and a frequency of 1-4 kHz, approximately). The gaps between the developing sleeves 83, 84 and the photosensitive drum 10 are approx. 150-400 μm in the developing zones A1 and A2. Therefore, a so-called jumping development is effected in the developing zones A1 and A2.

In the case that a post charger 100 carries out a constant-current-control in which a charging bias voltage current is applied to a discharge wire, a current flows also into the photosensitive drum 10 upon the discharging operation by which the amount of charge of the toner image can be increased. By doing so, the transfer operation of the toner image formed on the photosensitive drum 10 onto the intermediary transfer member (unshown) can be assisted. The charging bias voltage current may be a constant current of approx. −100-−200 μA having a DC component biased with an AC component approx. (1-5 kV).

The developer carried on the developing sleeves 83, 84 is kept carried on the developing sleeves 83, 84, unless it is used for the image formation. However, in the opposite side from the photosensitive drum 10, the developer carried on the developing sleeves 83, 84 is subjected to a pushing force arising from the supply of the developer by stirring members 51, 52, 53 and 54. When the pushing force is strong, the developer carried on the developing sleeves 83 and 84 are pushed out to the respective sleeve end portions by the supplied developer, with the result of developer leakage from the end portions of the sleeve. In this manner, in the developing apparatus 1 particularly that provided with two developing sleeves 83 and 84, the developer leakage from the sleeve end portions is a significant problem.

In the developing apparatus 1 of Embodiment 3, a pressure reducing member 102 is provided at a side remote or opposite from the photosensitive drum 10. The pressure reducing member 102 extends in a direction perpendicular to the sheet of the drawing between the developing sleeve 83 and the developing sleeve 84 at the side opposite from the photosensitive drum 10 and is substantially opposed to both of the developing sleeves 83, 84. The pressure reducing member 102 prevents the developer supplied by the stirring members 51, 52, 53, 54 from entering between the developing sleeve 83 and the developing sleeve 84. The pushing force applied to the developer carried on the developing sleeves 83, 84 with the supply of the developer by the stirring members 51, 52, 53 and 54 for reduced. In developing apparatus 1 of Embodiment 3, similarly to Embodiment 1 and/or Embodiment 2, the pressure reducing member 102 is provided with grooves 30 (FIG. 5) as a guiding portion. However, the grooves 30 are provided on at least one of a surface 102a opposing to the developing sleeve 83 and a surface 102b opposing to the developing sleeve 84.

### Comparison Example of Embodiment 3

The developer leakage from the sleeve end portion in Embodiment 3 and into conventional examples has been checked. In the checking, the configurations of the groove 30 and checking method are the same as those of Embodiment 1. Table 3 shows the results of comparison. Since in the developing apparatus 1 of Embodiment 3, the leakage from the neighborhood of the regulating blade attributable to the dragging of the developer does not occur, only the results of the end portion leakage mainly attributable to the movement of the developer in the neighborhood of the sleeve end portions are shown.

TABLE 3

| | |
|---|---|
| Conditions | Result of |

| | Reducing | Grooves of | leakage |
|---|---|---|---|
| | members | reducing members | Sleeve ends |
| Comp. | No | — | Yes |
| Ex. 7 | | | |
| Comp. | Yes | No | Yes |
| Ex. 8 | | | |
| Emb. 3 | Yes | Yes | No |

In comparison example 7, no pressure reducing member 102 is provided. In comparison example 7, the leakage is observed from the end portions of the developing sleeves 83, 84 intermittently from an initial stage of the test. This is because with the supply of the developer by the stirring members 51, 52, 53 and 54, the developer enters between the developing sleeve 83 and the developing sleeve 84, and the pushing force by the supplied developer increases. In comparison example 8, the pressure reducing member 102 provided with the grooves are provided. In comparison example 8, a significant improvement in the leakage prevention has been confirmed. However, with the advancement of the checking test, the leakage from the end portions gradually occurs. This is because although the pushing force is reduced by the pressure reducing member 102, the magnetic sealing member (unshown) becomes incapable of retaining the developer with the fixed operation proceeding.

As contrasted to comparison examples 7, 8, in Embodiment 3, the leakage from the end portions of the sleeves is hardly observed (Embodiment 3 in Table 3). This is because the pressure reducing member 102 is provided with the grooves 30 in Embodiment 3. In addition, this is also because of the formation of the grooves 30 in the groove regions 101c adjacent to the sleeve end portions including the carrying regions B and in the non-carrying regions C. By this, the pushing force applied to the developer carried on the developing sleeves 83 and 84 wherein the supply of the developer by the stirring members 51, 52, 53 and 54, by the pressure reducing member 102 can be reduced. In addition, by the grooves 30 formed on the pressure reducing member 102, the developer can be pushed back from the sleeve end portions to the central portion. As described in the foregoing, in the developing apparatus 1 of Embodiment 3 using one component developer, the effects similar to those of Embodiment 1 can be provided by the provision of the grooves 30 on the pressure reducing member 102.

In Embodiment 1 and Embodiment 2 described in the foregoing, the developing chamber 3 and the stirring chamber 4 are arranged vertically (vertical stirring type developing device), but the present invention is not limited to this type. More particularly, the present invention is applicable to a structure in which the developing chamber and the stirring chamber are arranged horizontally, and the chamber for supplying the developer of the developing sleeve and the chamber for collecting the developer from the developing sleeve have respective functions (function separation type).

In the foregoing, the grooves 30 are straight, but the present invention is not limited to this example, and the grooves 30 may be curved such as S shaped, arcuate, folded or the like.

The depths of the grooves 30 may be an even. For example, such a side of the dragging reducing member 101, or the pressure reducing member 102 as is closer to the portion into which the developer enters may have a small depth, and the side thereof remote from the portion may be large, in other words, the depth may be stepwisely changed. The cross-sectional configuration of the groove 30 may be U or V shaped or the like.

In the present invention, the reducing member 101, and the pressure reducing member 102 are provided with grooves 30, but the present invention is not limited to this example. For example, in place of the groove 30, the reducing member 101, on the pressure reducing member 102 may be provided with walls extending projected from the surface thereof. It will suffice if recess and projections are formed on the surface in the neighborhood of the opposite end portions of the reducing member 101, other pressure reducing member 102.

According to the present invention, the guiding portion is effective to guide the developer dragged by the developer carrying member from the end portions of the developer carrying member toward the central portion, and therefore, the movement of the developer toward the end portions is suppressed. By this, the developer leakage in the neighborhood of the end portions can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 228590/2013 filed Nov. 1, 2013, which is hereby incorporated by reference.

What is claimed is:

1. A developing apparatus comprising:
a developing container for containing a developer;
a rotatable developer carrying member provided at the position of said developing container opposed to an image bearing member and configured to carry the developer into a developing zone where said developer carrying member is opposed to said image bearing member; and
a guiding portion provided opposed to a carrying region, with respect to an axial direction of said developer carrying member, where said developer carrying member carries the developer, in a side of said developing container remote from said image bearing member, said guiding portion being capable of guiding the developer from an end portion of said developer carrying member with rotation of said developer carrying member.

2. An apparatus according to claim 1, further comprising a layer thickness regulating member provided opposed to said developer carrying member and configured to regulate a layer thickness of the developer carried to said developing zone by said developer carrying member, and a dragging reducing member configured to reduce the developer dragged by said developer carrying member in a position upstream of said layer thickness regulating member with respect to the rotational moving direction of said developer carrying member, wherein said guiding portion is provided on said dragging reducing member.

3. A developing apparatus comprising:
a developing container for containing a developer;
a first rotatable developer carrying member provided at the position of said developing container opposed to an image bearing member and configured to carry the developer into a first developing zone where said developer carrying member is opposed to said image bearing member;
a second developer carrying member rotatably provided downstream of said first developer carrying member with respect to a rotational moving direction of said image bearing member and configured to carry the developer into a second developing zone four said image bearing member; and
a guiding portion provided opposed to a carrying region, with respect to an axial directions of said first and second developer carrying members, where at least one of said first and second developer carrying members carries the developer, in a side of said developing container remote from said image bearing member, said guiding portion being capable of guiding the developer from an end portion of said developer carrying member with rotation of said developer carrying member.

4. An apparatus according to claim 3, further comprising a layer thickness regulating member provided opposed to said first developer carrying member and configured to regulate a layer thickness of the developer carried to said first developing zone by said first developer carrying member, and a dragging reducing member configured to reduce the developer dragged by said second developer carrying member in a position upstream of the region where said first developer carrying member and said second developer carrying member are close to each other with respect to the rotational moving direction of said developer carrying member, wherein said guiding portion is provided on said dragging reducing member.

5. An apparatus according to claim 1, wherein said guiding portion is disposed in a position opposed to said developer carrying member with a gap therebetween in a range including at least a boundary portion between the developer carrying region and a non-developer-carrying region.

6. An apparatus according to claim 1, wherein said guiding portion includes a plurality of grooves which are inclined relative to a rotational axis direction of said developer carrying member.

7. An apparatus according to claim 6, wherein angles formed between said grooves and a rotational axis of said developer carrying member is 30°-60°.

8. An apparatus according to claim 3, wherein said guiding portion is disposed in a position opposed to said developer carrying member with a gap therebetween in a range including at least a boundary portion between the developer carrying region and a non-developer-carrying region.

9. An apparatus according to claim 3, wherein said guiding portion includes a plurality of grooves which are inclined relative to a rotational axis direction of said developer carrying member.

10. An apparatus according to claim 9, wherein angles formed between said grooves and a rotational axis of said developer carrying member is 30°-60°.
